(19) United States
(12) Patent Application Publication
(10) Pub. No.: US 2023/0107783 A1
(43) Pub. Date: Apr. 6, 2023

(54) IN-VEHICLE INFORMATION PROCESSING APPARATUS, INFORMATION PROCESSING METHOD, AND SERVER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Tetsuya NODA, Yokkaichi-shi, Mie (JP)

(21) Appl. No.: 17/907,240

(22) PCT Filed: Mar. 16, 2021
(86) PCT No.: PCT/JP2021/010671

§ 371 Date: Sep. 23, 2022

(30) Foreign Application Priority Data
Mar. 26, 2020 (JP) 2020-056690

(51) Int. Cl. G06F 16/953; B60W 50/06; B60W 50/029

(52) U.S. Cl. CPC G06F 16/953; B60W 50/06; B60W 50/029

(57) ABSTRACT

In an in-vehicle information processing apparatus according to the present embodiment, a server processing unit receives a search message for searching for a requested service, from a client processing unit configured to request that a service be provided, the search message includes identification information and version information of the requested service, the server processing unit determines whether or not the version information included in the received search message matches version information of a service that the server processing unit provides, and, if it is determined that the two types of version information do not match, the server processing unit examines whether or not it is possible to provide the service with different version information to the client processing unit, and, if it is possible to provide the service with different version information, the server processing unit provides the service to the client processing unit.

### CROSS-REFERENCE TO RELATED APPLICATIONS

This application is the U.S. national stage of PCT/JP2021/010671 filed on Mar. 16, 2021, which claims priority of Japanese Patent Application No. JP 2020-056690 filed on Mar. 26, 2020, the contents of which are incorporated herein.

### TECHNICAL FIELD

The present disclosure relates to an in-vehicle information processing apparatus, an information processing method, and a server program for performing processing for providing a service to a client.

### BACKGROUND

In recent years, development and the like of automated driving functions of vehicles has advanced, and there are demands for controlling more sophisticated in-vehicle systems. SOME/IP (Scalable service-Oriented MiddlewarE over IP) has been garnering attention as an architecture of service-oriented middleware for realizing such demands.

JP 2016-163244A proposes an ECU (Electronic Control Unit) that transmits identification information of a new service to an external apparatus before starting to provide the new service, tests the new service in accordance with a test instruction from the external apparatus and transmits a test result to the external apparatus, and starts to provide the new service if determination information indicating that provision of the new service is permitted is received from the external apparatus. After receiving the identification information from the ECU, the external apparatus transmits the test instruction to the ECU, receives the result of the test, determines whether or not to permit provision of a new service based on the received result, and transmits the determination information to the ECU.

Information such as a service ID, a version, and the like is set for a service that is provided by a server in accordance with SOME/IP. A client that desires a service to be provided designates a service ID and a version, and performs a search to determine whether or not the service is being provided. When, for example, a server program for providing a service has been subjected to a version upgrade, while a client program has not been subjected to a version upgrade, the version of the service that is provided by the server and the version of the service desired by the client do not match, and a situation can arise where the client cannot receive the desired service.

The present disclosure has been made in light of such a situation, and an object of the present disclosure is to provide an in-vehicle information processing apparatus, an information processing method, and a server program with which it is possible to expect that a situation where a client cannot receive a service due to a version mismatch will be avoided whenever possible.

### SUMMARY

An in-vehicle information processing apparatus according to one aspect of the present disclosure is an in-vehicle information processing apparatus that includes a server processing unit configured to perform processing for providing a service in response to a request, the server processing unit receives a search message for searching for a requested service, from a client processing unit configured to request that a service be provided, the search message includes identification information and version information of the requested service, the server processing unit determines whether or not the version information included in the received search message matches version information of a service that the server processing unit is to provide, and, if it is determined that the two types of version information do not match, the server processing unit examines whether or not it is possible to provide the service with different version information to the client processing unit, and, if it is possible to provide the service with different version information, the server processing unit provides the service to the client processing unit.

The instant disclosure can be realized not only as an apparatus that includes such a characteristic processing unit, but also as a method that includes the characteristic processing as steps, or as a computer program for causing a computer to execute these steps. The present disclosure can also be realized as a semiconductor integrated circuit that realizes some or all of these devices, or as another device or system that includes these devices.

### Advantageous Effects

According to the above, it is possible to expect that a situation where a client cannot receive a service due to a version mismatch will be avoided, whenever possible.

### BRIEF DESCRIPTION OF DRAWINGS

FIG. 1 is a schematic diagram for illustrating the configuration of an in-vehicle information processing system according to an embodiment of the present disclosure.

FIG. 2 is a schematic diagram for illustrating communication performed in an in-vehicle information processing system according to an embodiment of the present disclosure.

FIG. 3 is a schematic diagram for illustrating communication performed in an in-vehicle information processing system according to an embodiment of the present disclosure.

FIG. 4 is a block diagram showing the configuration of an ECU on a client side according to an embodiment of the present disclosure.

FIG. 5 is a block diagram showing the configuration of an ECU on a server side according to an embodiment of the present disclosure.

FIG. 6 is a schematic diagram showing a configuration example of a search message and a service providing message transmitted/received in an in-vehicle information processing system according to an embodiment of the present disclosure.

FIG. 7 is a schematic diagram showing a configuration example of a request message and a response message transmitted/received in an in-vehicle information processing system according to an embodiment of the present disclosure.

FIG. 8 is a schematic diagram for illustrating an example of processing that is performed in an in-vehicle information processing system according to an embodiment of the present disclosure.

FIG. 9 is a schematic diagram for illustrating an example of processing that is performed in an in-vehicle information processing system according to an embodiment of the present disclosure.

FIG. 10 is a flowchart showing a procedure of processing that is performed by an ECU serving as a client according to an embodiment of the present disclosure.

FIG. 11 is a flowchart showing a procedure of processing that is performed by an ECU serving as a server according to an embodiment of the present disclosure.

FIG. 12 is a flowchart showing a procedure of examination processing performed by an ECU serving as a server according to an embodiment of the present disclosure.

FIG. 13 is a flowchart showing a procedure of other processing performed by an ECU of a server according to an embodiment of the present disclosure.

FIG. 14 is a schematic diagram for illustrating an example of processing performed in an in-vehicle information processing system according to Modified Example 1.

FIG. 15 is a schematic diagram for illustrating the configuration of an in-vehicle information processing system according to Modified Example 2.

### DETAILED DESCRIPTION OF PREFERRED EMBODIMENTS

First, aspects of the present disclosure will be listed and described. At least some of the aspects described below may be discretionarily combined.

### First Aspect

An in-vehicle information processing apparatus according to a first aspect of the present disclosure is an in-vehicle information processing apparatus that includes a server processing unit configured to perform processing for providing a service in response to a request, the server processing unit receives a search message for searching for a requested service, from a client processing unit configured to request that a service be provided, the search message includes identification information and version information of the requested service, the server processing unit determines whether or not the version information included in the received search message matches version information of a service that the server processing unit is to provide, and, if it is determined that the two types of version information do not match, the server processing unit examines whether or not it is possible to provide the service with different version information to the client processing unit, and, if it is possible to provide the service with different version information, the server processing unit provides the service to the client processing unit.

In the first aspect, the server processing unit of the in-vehicle information processing apparatus receives a search message for searching for a service, from the client processing unit that has requested that a service be provided. This search message includes identification information and version information of the service that the client processing unit needs, and the server processing unit determines whether or not the version information included in the received search message and version information of a service that the server processing unit is to provide match. If the two types of version information match, the server processing unit performs processing for providing this service to the client processing unit. If the two types of version information don't match, the server processing unit performs examination as to whether or not the client processing unit can be provided with the service with different version information. As a result of the examination, if the client processing unit can be provided with the service with different version information, the server processing unit performs information processing for providing the service requested by the client processing unit. Accordingly, with the server processing unit of the in-vehicle information processing apparatus, it is possible to expect that a situation where the client processing unit cannot receive a service due to a mismatch of version information of the service will be avoided whenever possible.

### Second Aspect

In a second aspect, if it is possible to provide the service with different version information, the server processing unit changes version information of a service that is to be provided to the client processing unit from this point on, to the version information included in the search message.

In the second aspect, as a result of examination, if the client processing unit can be provided with the service with different version information, the server processing unit changes version information of a service that the server processing unit is to provide to this client processing unit from this point on, to the version information included in the search message received from the client processing unit. Accordingly, a mismatch of version information will not occur from this point on, and it is possible to expect that the client processing unit will perform processing smoothly.

### Third Aspect

In a third aspect, the server processing unit temporarily changes the version information of the service that the server processing unit is to provide, to the version information included in the search message, transmits/receives a message to/from the client processing unit based on the temporarily changed version information, and performs examination as to whether or not it is possible to provide the service with different version information, based on a result of the transmitted/received message.

In the third aspect, when performing examination as to whether or not the client processing unit can be provided with the service with different version information, the server processing unit first temporarily changes the version information of the service that the server processing unit is to provide, to the version information included in the search message received from the client processing unit. The server processing unit then transmits/receives a message related to provision of the service to/from the client processing unit based on the changed version information. The server processing unit performs examination as to whether or not the client processing unit can be provided with the service with different version information, a result of the transmitted/received message. Accordingly, the in-vehicle information processing apparatus can perform examination as to whether or not a failure will occur, etc., when the version information of the service that the in-vehicle information processing apparatus is to provide is changed to the version information of the service demanded by the client processing unit (to be provided).

### Fourth Aspect

[In a fourth aspect, the server processing unit gives the client processing unit an instruction to transmit a predetermined message, receives a message transmitted by the client processing unit in response to the instruction, and performs examination based on the received message.

In the fourth aspect, the server processing unit gives the client processing unit an instruction to transmit a predetermined message, and performs examination based on a message transmitted by the client processing unit in response to the instruction. Accordingly, the server processing unit can perform more accurate examination as to whether or not the client processing unit can be provided with the service with different version information.

### Fifth Aspect

In a fifth aspect, the server processing unit receives a search message transmitted by the client processing unit in order to search for a service that the client processing unit desires to be provided, and transmits, as a response to the search message, a service providing message that includes the identification information and the version information of the service that the server processing unit is to provide.

In the fifth aspect, the server processing unit of the in-vehicle information processing apparatus receives a search message for searching for a service that the client processing unit desires to be provided, from the client processing unit, and transmits, as a response to this search message, a service providing message that includes identification information and version information of a service that the server processing unit is to provide. Accordingly, when a service providing message from the server processing unit is necessary, the client processing unit can transmit a search message and receive a service providing message.

### Sixth Aspect

In a sixth aspect, the server processing unit repeatedly transmits, in a predetermined cycle, a service providing message that includes the identification information and the version information of the service that the server processing unit is to provide.

In sixth aspect, the server processing unit of the in-vehicle information processing apparatus repeatedly transmits, in a predetermined cycle, a service providing message that includes identification information and version information of a service that the server processing unit is to provide. Accordingly, the client processing unit receives a periodically transmitted service providing message, and can determine whether or not a service that the client processing unit needs is provided, and determines which server processing unit provides a service.

### Seventh Aspect

In a seventh aspect, the server processing unit transmits/receives a message to/from another apparatus that includes the client processing unit.

In the seventh aspect, the server processing unit of the in-vehicle information processing apparatus transmits/receives a message to/from another apparatus that includes the client processing unit. Accordingly, the in-vehicle information processing apparatus can perform processing for providing a service that the other apparatus needs.

### Eighth Aspect

In an eighth aspect, the client processing unit is provided.

In the eighth aspect, the in-vehicle information processing apparatus that includes the server processing unit further includes the client processing unit. Accordingly, the in-vehicle information processing apparatus can perform processing for providing a service to the client processing unit in the apparatus, using a method similar to a method for providing a service to an external apparatus.

### Ninth Aspect

An information processing method according to a ninth aspect of the present disclosure is an information processing method in which a server processing unit of an in-vehicle information processing apparatus performs processing for providing a service in response to a request from a client processing unit, the method including: receiving a search message for searching for a requested service, from a client processing unit configured to request that a service be provided, the search message including identification information and version information of the requested service, determining whether or not the version information included in the received search message matches version information of a service that the server processing unit is to provide, and, if it is determined that the two types of version information do not match, examining whether or not it is possible to provide the service with different version information to the client processing unit, and, if it is possible to provide the service with different version information, providing the service to the client processing unit.

In the ninth aspect, similarly to the first aspect, it is possible to expect that a situation where a service cannot be received due to a mismatch of version information of the service will be avoided.

### Tenth Aspect

A server program according to a tenth aspect of the present disclosure causes a computer mounted in a vehicle to execute processing for receiving a search message for searching for a requested service, from a client program for requesting that a service be provided, the search message including identification information and version information of the requested service, determining whether or not the version information included in the received search message matches version information of a service that the server program provides, and, if it is determined that the two types of version information do not match, examining whether or not it is possible to provide the service with different version information to the client program, and, if it is possible to provide the service with different version information, providing the service to the client program.

In this aspect, similarly to the first aspect, it is possible to expect that a situation where a service cannot be received due to a mismatch of version information of the service will be avoided whenever possible.

Specific examples of an in-vehicle information processing system according to embodiments of the present disclosure will be described below with reference to the drawings. The present disclosure is not restricted to these illustrative examples and is defined by the claims, and all changes that come within the meaning and range of equivalency of the claims are intended to be embraced therein.

### System Configuration

FIG. 1 is a schematic diagram for illustrating the configuration of an in-vehicle information processing system according to an embodiment of the present disclosure. The in-vehicle information processing system according to the present embodiment is a system that performs various types of information processing related to travelling control and the like of a vehicle 1 as a result of a plurality of ECUs 2 and 3 mounted in the vehicle 1 performing communication via a relay device 4, and cooperating with each other. The in-vehicle information processing system shown in FIG. 1 has a star network configuration in which one ECU 2 and three ECUs 3 are connected to one relay device 4 via individual communication lines. Note that the number of apparatuses included in the in-vehicle information processing system, the network configuration, and the like are exemplary, and there is no limitation thereto. The total number of ECUs 2 and 3 included in the in-vehicle information processing system may also be three or less, or five or more. In addition, a plurality of ECUs 2 and 3 may be connected in a bus network configuration, a ring network configuration or the like.

The ECUs 2 and 3 are information processing apparatuses mounted in the vehicle 1. The ECUs 2 and 3 may include various ECUs such as an ECU that controls automated driving of the vehicle 1, an ECU that controls the operation of the engine, an ECU that controls the locking and unlocking of a door, an ECU that turns a light on and off, an ECU that controls the operation of an airbag, and an ECU that controls the operation of the ABS (Antilock Brake System). Note that, in the present embodiment, an in-vehicle information processing apparatus is one of the ECUs 2 and 3, but there is no limitation thereto, and an in-vehicle information processing apparatus may be various apparatuses other than the ECUs 2 and 3.

The relay device 4 is a device that includes a plurality of ports for connecting communication lines, and relays messages transmitted/received between communication lines connected to these ports. The relay device 4 is a device such as a switching hub or a gateway, for example. The relay device 4 transmits a message received on one communication line, from another communication line, and thereby relays transmission/receiving of the message. Note that, for example, if a bus network configuration in which the plurality of ECUs 2 and 3 are connected to a common communication line is adopted, the in-vehicle information processing system does not need to include the relay device 4.

In the in-vehicle information processing system according to the present embodiment, messages are transmitted/received between the ECUs 2 and 3 in accordance with a SOME/IP communication standard. The SOME/IP standard is a standard classified as a fifth layer or a higher layer of the OSI reference model, and communication is performed in a mode of a request for a service or a response to the request, which are transmitted between application programs. In the present embodiment, the ECU 2 is an apparatus on the server side that provides a service, and an ECU 3 is an apparatus on the client side that is provided with a service. Note that this relation between a client and a server is exemplary, and each of the ECUs 2 and 3 can be a client or a server. Note that any standard may be adopted for communication on a fourth layer or a lower layer of the OSI reference model, and, for example, a standard of Ethernet (registered trademark), TCP (Transmission Control Protocol), UDP (User Datagram Protocol), or the like can be adopted.

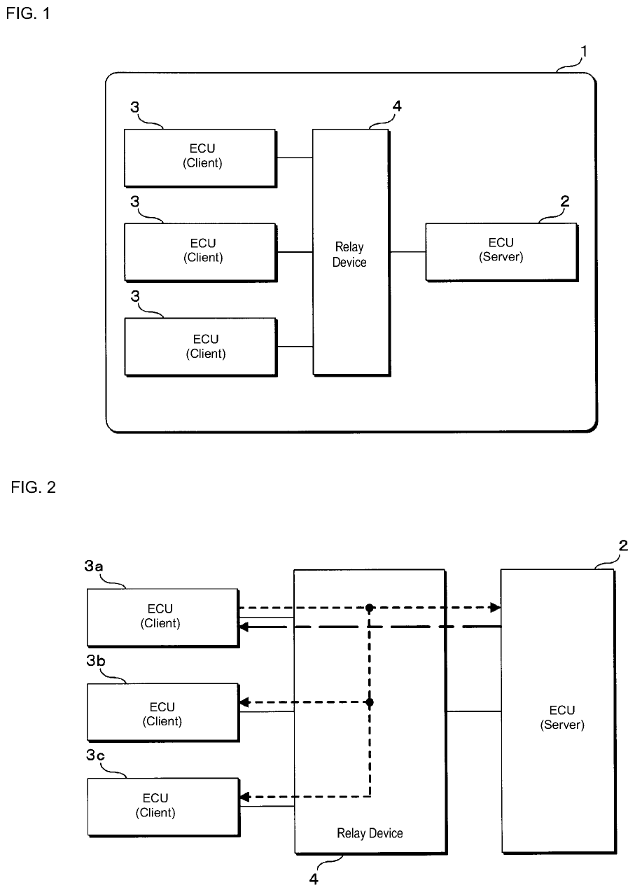

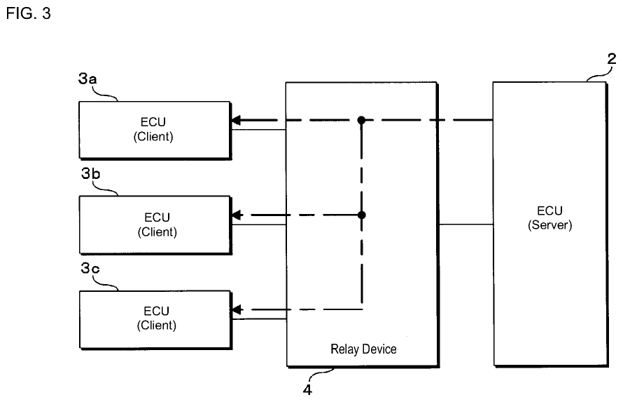

FIGS. 2 and 3 are schematic diagrams for illustrating communication performed in the in-vehicle information processing system according to the present embodiment. In FIGS. 2 and 3, the three ECUs 3 are respectively given different reference signs, namely 3a, 3b, and 3c in order to distinguish them from one another. As shown in FIG. 2, for example, the ECU 3a transmits a search message (search frame) for searching for a service that the ECU 3a needs, at a predetermined timing such as after startup or restart. In the present embodiment, the ECU 3a transmits a search message using a transmission method for simultaneously transmitting one message to a plurality of apparatuses, that is, so-called multicasting. Accordingly, the search message transmitted by the ECU 3a is received by the ECUs 2, 3b, and 3c (in FIG. 2, transmission/receiving of a search message is indicated by broken line arrows).

The search message transmitted by the ECU 3a includes a service ID for identifying the service that the ECU 3a needs and a service version for identifying the version of software (server program) providing this service. The ECUs 2, 3b, and 3c that have received the search message determine whether or not it is possible to provide a service whose service ID and service version match the service ID and the service version included in the received search message. In this example, the ECU 2 can provide such a service, and the ECU 2 transmits a service providing message (service provision frame) indicating that a service can be provided, to the ECU 3a that transmitted the search message. At this time, the ECU 2 transmits a service providing message using a transmission method in which a message is transmitted to one ECU, namely the ECU 3a, through so-called unicasting (In FIG. 2, transmission/receiving of a service providing message is indicated by dashed-dotted line arrows).

The ECU 3a that receives the service providing message transmitted from the ECU 2 can determine, based on the service providing message, that there is an apparatus that can provide a service, and that the apparatus is the ECU 2. The service providing message includes information such as a service ID and a service version and information such as the IP address and the port number of the server (the ECU 2) that can provide the service. From this point on, the ECU 3a transmits, to the ECU 2, a request to provide information regarding this service and the like, and, in response to this request, the ECU 2 transmits a response that includes information regarding the service, to the ECU 3a. Accordingly, the service is provided by the ECU 2 serving as a server, to the ECU 3a serving as a client, and the ECU 3a can perform various types of information processing that uses the service provided by the ECU 2.

In addition, in the present embodiment, a service providing message is not only transmitted as a response to a search message, but is also transmitted autonomically in a predetermined cycle by the ECU 2 that provides a service. The ECU 2 that can provide a service repeatedly transmits a service providing message that includes information regarding the service that the ECU 2 provides, in a predetermined cycle, for example, about several milliseconds to several seconds. As shown in FIG. 3, when periodically transmitting a service providing message, the ECU 2 performs transmission using a transmission method for simultaneously transmitting one service providing message to a plurality of apparatuses, through so-called multicasting. Accordingly, a service providing message transmitted by the ECU 2 is received by the ECUs 3a, 3b, and 3c (in FIG. 3, transmission/receiving of a service providing message is indicated by dashed-dotted line arrows).

A service providing message that is transmitted in response to a search message and a service providing message that is periodically transmitted may be the same, and the ECU 3a that receives these messages can become aware that, as described above, the ECU 2 provides a service that the ECU 3a needs, and can transmit a request related to the service to the ECU 2 from this point on. Upon receiving a service providing message that is periodically transmitted, the ECUs 3b and 3c that do not need the service may discard (ignore) this message.

In this manner, in the in-vehicle information processing system according to the present embodiment, the ECU 3a on the client side that requires a service needs to be aware of the ECU 2 that provides the required service, based on a service providing message in advance. After it is found that the ECU 2 provides the service, the ECU 3a transmits/receives messages to/from the ECU 2, and can be provided with the service from the ECU 2 and perform information processing. The ECU 3a transmits a request message for requesting that the service be provided, to the ECU 2, and, as a response to this request message, the ECU 2 transmits a response message to the ECU 3a.

Note that, in the present embodiment, a service that is provided by the ECU 2 serving as a server can be processing for providing information that the ECU 2 has, for example, processing for transmitting a message that includes various types of information such as the vehicle speed of the vehicle 1 or a detection result of an object near the vehicle 1, to the ECU 3a that has made the request. In addition, for example, assuming that the ECU 2 is an apparatus that controls an in-vehicle device such as a light, a lock of a door/a door lock, or the like of the vehicle 1, the ECU 2 can provide a service for controlling such an in-vehicle device in response to a request from the ECU 3a. A service that is provided by the ECU 2 serving as a server is not limited to those described above, and may be various types of processing.

Here, the ECUs 2 and 3a to 3c included in the in-vehicle information processing system can be subjected to a version upgrade as a result of software thereof being updated. A version upgrade may be performed on all of the apparatuses in the in-vehicle information processing system at a time, but may also be performed individually on each apparatus. Therefore, for example, a situation can arise where the software of the ECU 3a that is provided with this service has been subjected to a version upgrade, while the software of the ECU 2 that provides the service has not been subjected to a version upgrade. In such a situation, even if the ECU 3a transmits a search message in which a service is designated in a new version, the ECU 2 that receives this message does not transmit a service providing message to the ECU 3a since the version of the service provided by the ECU 2 and the version of the designated service are different, and the ECU 3a cannot receive the service. Also, the ECU 2 periodically transmits a service providing message in which a service is designated in an old version, but the ECU 3a that receives this message does not transmit a message for requesting a service to the ECU 2 since the version of the service in this message is different from the version of the service that the ECU 3a desires. Accordingly, the service cannot be provided from the ECU 2 to the ECU 3a.

In view of this, in the in-vehicle information processing system according to the present embodiment, when there is a client side ECU 3a that desires the provision of a service whose service ID is the same as that of a service that the ECU 2 provides and which is of a different service version, the ECU 2 on the server side examines whether or not the ECU 3a on the client side can be provided with this service. As a result of the examination, if it is determined that the ECU 3a on the client side can be provided with the service of a different service version, the ECU 2 on the server side can perform processing for providing the service to the ECU 3a serving as a client.

### Apparatus Configuration

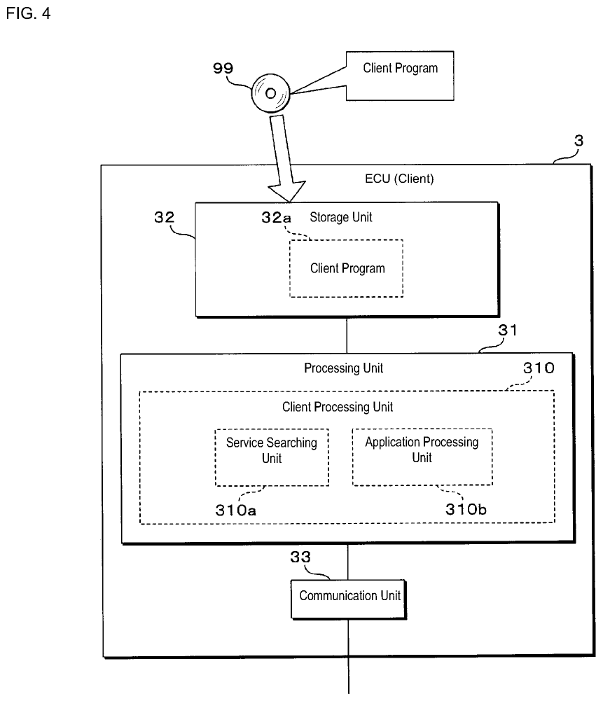

FIG. 4 is a block diagram showing the configuration of an ECU 3 on the client side according to the present embodiment. The ECU 3 according to the present embodiment is constituted by a processing unit (processor) 31, a storage unit (storage) 32, a communication unit (transceiver) 33, and the like. The processing unit 31 is constituted by using a computation processing apparatus such as a CPU (Central Processing Unit) or an MPU (Micro-Processing Unit). The processing unit 31 can perform various types of processing such as processing for searching for a server that provides a required service and information processing that is based on a service provided by a server, by reading out and executing a client program 32a stored in the storage unit 32.

The storage unit 32 is constituted by using a nonvolatile memory device such as a flash memory or an EEPROM (Electrically Erasable Programmable Read-Only Memory). The storage unit 32 stores various programs that are executed by the processing unit 31, and various types of data necessary for processing performed by the processing unit 31. In the present embodiment, the storage unit 32 stores the client program 32a that is executed by the processing unit 31.

The client program 32a may be written in the storage unit 32 at a manufacturing stage of the ECU 3, for example. Also, for example, the client program 32a may be distributed by a remote server apparatus or the like, obtained by the ECU 3 through communication with the server apparatus, and written in the storage unit 32. Moreover, the client program 32a recorded on a recording medium 99 such as a memory card or an optical disk may be read out by the ECU 3 and stored in the storage unit 32. Moreover, for example, the client program 32a recorded on the recording medium 99 may be read out by a writing apparatus and written in the storage unit 32 of the ECU 3. The client program 32a may also be provided in a mode of being distributed via a network, or in a mode of being recorded on the recording medium 99.

The communication unit 33 is connected to a communication line disposed in the vehicle 1, and transmits/receives messages to/from the other ECUs 2 and 3 via this communication line. In the present embodiment, the communication unit 33 transmits/receives messages in accordance with an Ethernet communication standard, for example. The communication unit 33 can be constituted by using an IC (Integrated Circuit) of Ethernet PHY (physical layer) or the like. Note that the communication standard that is used by the communication unit 33 is not limited to Ethernet, and various communication standards such as those of a CAN (Controller Area Network), FlexRay, and the like can also be used. The communication unit 33 transmits messages by outputting data provided from the processing unit 31, as an electrical signal to the communication line. Also, the communication unit 33 samples and obtains the potential of the communication line, thereby converting an electrical signal on the communication line into digital data, and providing the resultant data as a received message to the processing unit 31.

In addition, in the ECU 3 according to the present embodiment, a client processing unit 310 is realized as a software-like function unit by the processing unit 31 reading out and executing the client program 32a stored in the storage unit 32. The client processing unit 310 performs various types of processing as a client that is provided with a service, in accordance with the SOME/IP standard. In the present embodiment, the client processing unit 310 includes a service searching unit 310a, an application processing unit 310b, and the like.

The service searching unit 310a performs processing for searching for a server that provides a service required for processing performed by the client processing unit 310. The service searching unit 310a transmits a search message in which the service ID and the service version of the service required for the processing that is performed by the client processing unit 310 are designated, from the communication unit 33 through multicasting. The service searching unit 310a receives a service providing message transmitted from a server in response to the search message transmitted by the service searching unit 310a, and obtains information such as the IP address and the port number included in the received service providing message, thereby determining whether or not there is a server that provides the service, and obtaining information required for communication with the server. Also, the service searching unit 310a receives a service providing message that is periodically transmitted by the server, and obtains information such as the IP address and the port number included in the received service providing message, thereby determining whether or not there is a server that provides the service, and obtaining information required for communication with the server.

The application processing unit 310b performs information processing related to an application specific to the ECU 3, using a provided service. The application processing unit 310b transmits a request message in which a service ID and a service version are designated, to a server found by the service searching unit 310a, and receives a response message transmitted in response to this request message. The application processing unit 310b obtains information included in the received response message, and performs various types of information processing based on the obtained information. The application processing unit 310b, for example, transmits a request message requesting the server to transmit information regarding the vehicle speed of the vehicle 1, obtains information regarding the vehicle speed included in a response message received from the server in response to this request message, and can perform various types of information processing that uses the vehicle speed. Information processing that is performed by the application processing unit 310b using a service provided from a server may be any kind of processing.

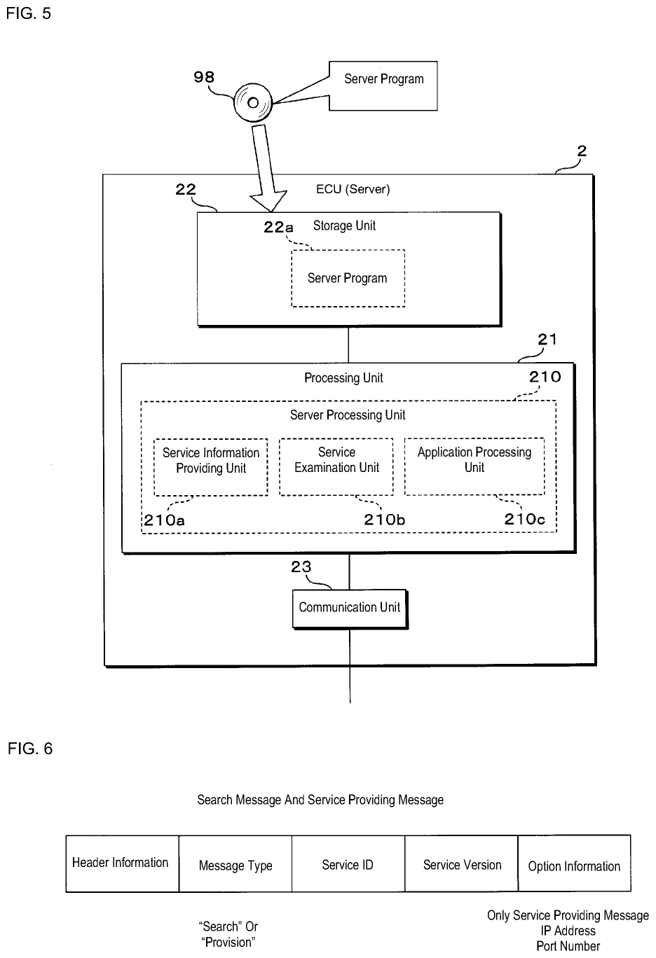

FIG. 5 is a block diagram showing the configuration of the ECU 2 on the server side according to the present embodiment. The ECU 2 according to the present embodiment is constituted by a processing unit (processor) 21, a storage unit (storage) 22, a communication unit (transceiver) 23, and the like. The processing unit 21 is constituted by using a computation processing apparatus such as a CPU or an MPU. The processing unit 21 can perform various types of processing such as processing for performing notification of a service that is to be provided in response to a search for a service and processing for providing a service to a client, by reading out and executing a server program 22a stored in the storage unit 22.

The storage unit 22 is constituted by using a nonvolatile memory device such as a flash memory or an EEPROM. The storage unit 22 stores various programs executed by the processing unit 21 and various data required for processing that is performed by the processing unit 21. In the present embodiment, the storage unit 22 stores the server program 22a executed by the processing unit 21.

The server program 22a may be written in the storage unit 22 in a manufacturing stage of the ECU 2, for example. Also, for example, the server program 22a may be distributed by a remote server apparatus or the like, obtained by the ECU 2 through communication with the server apparatus, and written in the storage unit 22. Moreover, the server program 22a recorded on a recording medium 98 such as a memory card or an optical disk may be read out by the ECU 2 and stored in the storage unit 22. Moreover, for example, the server program 22a recorded on the recording medium 98 may be read out by a writing apparatus and written in the storage unit 22 of the ECU 2. The server program 22a may also be provided in a mode of being distributed via a network, or in a mode of being recorded on the recording medium 98.

The communication unit 23 is connected to a communication line disposed in the vehicle 1, and transmits/receives messages to/from another ECU 3 via this communication line. In the present embodiment, the communication unit 23 transmits/receives messages in accordance with the Ethernet communication standard, for example. The communication unit 23 can be constituted by using an IC of an Ethernet PHY or the like. Note that the communication standard that is used by the communication unit 23 is not limited to Ethernet, and various communication standards such as those of a CAN, FlexRay, and the like can also be used. The communication unit 23 transmits messages by outputting data provided from the processing unit 21 as an electrical signal to the communication line. Also, the communication unit 23 samples and obtains the potential of the communication line, thereby converting an electrical signal on the communication line into digital data, and providing the resultant data as a received message to the processing unit 21.

In addition, in the ECU 2 according to the present embodiment, a server processing unit 210 is realized as a software-like function unit by the processing unit 21 reading out and executing the server program 22a stored in the storage unit 22. The server processing unit 210 performs various types of processing as a server that provides a service, in accordance with the SOME/IP standard. In the present embodiment, the server processing unit 210 includes a service information providing unit 210a, a service examination unit 210b, an application processing unit 210c, and the like.

The service information providing unit 210a performs processing for transmitting a service providing message that includes information regarding a service that the ECU 2 provides. When a search message from a client is received, the service information providing unit 210a determines whether or not the service ID and the service version included in this search message respectively match the service ID and the service version of the service that the ECU 2 provides. If the service IDs and the service versions match, the service information providing unit 210a transmits a service providing message to the client that transmitted the search message, through unicasting. In addition, the service information providing unit 210a transmits a service providing message that includes information regarding the service that the ECU 2 provides, in a predetermined cycle through multicasting.

When an ECU 3 serving as a client requests that a service whose service ID matches the service ID of the service that the ECU 2 provides and whose service version is different from the service version of the service that the ECU 2 provides, the service examination unit 210b performs processing for examining whether or not the ECU 3 can be provided with this service of a different service version. The service examination unit 210b obtains the service ID and the service version included in the search message received from the client ECU 3, and, if the service ID in the search message and the service ID of the service that the ECU 2 provides match, and the service version in the search message and the service version of the service that the ECU 2 provides do not match, the service examination unit 210b starts examination processing. The service examination unit 210b temporarily changes the service version of the service that the ECU 2 provides to the client ECU 3 that is an examination target, to the service version in the search message. The service examination unit 210b transmits a service providing message in which the changed service version is set, to the ECU 3 that is an examination target.

The ECU 3 that receives this service providing message determines that the ECU 2 provides the service that the ECU 3 desires to be provided, and transmits a request message to use this service to the ECU 2. The request message includes information regarding the service ID and the service version of the service that the ECU 3 requests. The service examination unit 210b of the ECU 2 receives the request message from the ECU 3, and determines whether or not the received request message is proper. The service examination unit 210b receives a predetermined number of (for example, 10) request messages from the ECU 3, and, when, from among the predetermined number of request messages, the number of request messages determined as being proper exceeds a threshold value (for example, 5), determines that the ECU 3 can be provided with the service of a different service version. If the number of request messages determined as being proper does not exceed the threshold value, the service examination unit 210b determines that the ECU 3 cannot be provided with the service of a different service version.

In addition, the service examination unit 210b can determine whether or not each request message received from the ECU 3 is proper using the following methods, for example.
Whether or not various types of ID information and the like included in a request message have proper values.
Whether or not a change, such as an increase or decrease, in the value of a session ID or the like each time a request message is transmitted is proper.
Whether or not a value such as an argument or a return value related to a request for a service is within a proper range.

Note that a method for determining whether or not a request message is proper is not limited to the above-described methods. When, for example, transmission/receiving of a message between the ECUs 2 and 3 comply with the SOME/IP standard, the service examination unit 210b may determine whether or not an error is to be determined in accordance with the SOME/IP standard, as the above-described method for determining whether or not a request message is proper.

If it is determined that the ECU 3 cannot be provided with the service of a different service version, the service examination unit 210b returns the temporarily changed service version of the service to the original version, and, from this point on, does not respond to a search message and a request message received from this ECU 3 (note that this applies only to a message that includes the same service ID as a service ID for which examination has been performed). Therefore, the ECU 3 serving as a client cannot be provided with a service from this ECU 2.

If it is determined that the ECU 3 can be provided with the service of a different service version, the service examination unit 210b maintains the temporarily changed service version of the service without returning it to the original version, in other words, permanently changes the service version. The service examination unit 210b responds with the changed service version to a search message and a request message received from this ECU 3 from this point on. That is to say, the ECU 2 sets the changed service version as a service version included in a service providing message and a response message to be transmitted to this ECU 3.

The application processing unit 210c performs information processing for providing a service specific to the ECU 2. The application processing unit 210c receives a request message from an ECU 3 serving as a client, and obtains the service ID and the service version included in the received request message. The application processing unit 210c performs information processing for providing a service corresponding to the obtained service ID and service version. The application processing unit 210c generates a response message that includes information obtained as a result of the information processing, and transmits the response message to the client that transmitted the request message.

### Processing Performed by Client and Server

FIG. 6 is a schematic diagram showing a configuration example of a search message and a service providing message transmitted/received in the in-vehicle information processing system according to the present embodiment. A search message that an ECU 3 serving as a client according to the present embodiment transmits and a service providing message that the ECU 2 serving as a server transmits may include information such as header information, a message type, a service ID, a service version, and option information.

The header information of a message is an Ethernet header, an IP header, a TCP/UDP header, a SOME/IP header, or the like, and is for storing information defined in accordance with the communication standard. The header information can store information such as a MAC address, an Ethernet type, an IP address, and a port number. The format of the header information may be any format, and information stored in the header information may be any information.

The “message type” stores information indicating whether this message is a search message or a service providing message. The message is a search message if “0” is set in the “message type”, and is a service providing message if “1” is set, for example.

The service ID is identification information that is uniquely assigned to a service that the server provides. The service version is information for identifying the version of the service that is provided, and is the version of the software that is operated by the server in order to provide the service identified by the service ID, for example. In the present embodiment, a larger numerical value of a service version indicates a newer version. The service ID and the service version included in a search message are the service ID and the service version of the service that the client desires to be provided by the server. The service ID and the service version included in a service providing message are the service ID and the service version of a service that the server can provide.

In the present embodiment, the option information is information that is assigned to a service providing message, and includes information such as the IP address and the port number of the server that provides the service. Note that, similarly, information such as the IP address and the port number of a client may also be added to a search message as option information.

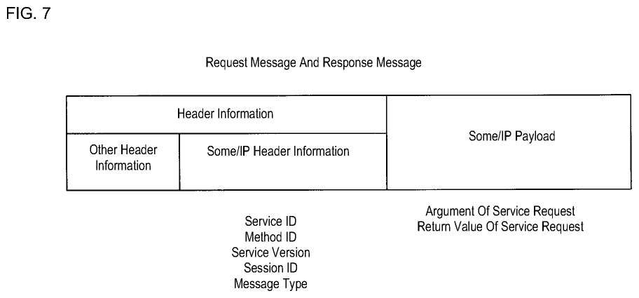

FIG. 7 is a schematic diagram showing a configuration example of a request message and a response message transmitted/received in the in-vehicle information processing system according to the present embodiment. A request message is a message for a client to request a server to provide a service. In addition, a response message is a message that is transmitted by a server as a response to a request message from a client. A request message that is transmitted by an ECU 3 serving as a client and a response message that is transmitted by the ECU 2 serving as a server according to the present embodiment include header information that includes header information for the SOME/IP standard and header information for another standard, and a SOME/IP payload. The “SOME/IP header information” can include information such as a service ID, a method ID, a service version, a session ID, and a message type. The “SOME/IP payload” can include information such as an argument related to a request for a service or a return value related to a request for a service.

The service ID and the service version included in the “SOME/IP header information” are as described above. The method ID is an ID for designating which method is to be used, from among a plurality of methods that are provided for the service designated by the service ID. When, for example, a numerical value that designates a vehicle information providing service is set as a service ID, a numerical value that designates a method for providing the vehicle speed, a method for providing the acceleration rate, a method for providing a steering angle, or the like can be set as a method ID.

The session ID is numerical value information that is increased (the value of the session ID is increased by 1) every time a service is requested and provided, for example. When, for example, the client transmits a service request in which the session ID=1, and receives a service response in which the session ID=1 in response to this service request, the client will transmit a service request in which the session ID=2, next time. When a desired service response is not received, the client can set the same session ID and retransmit a service request.

In the “message type”, a numerical value indicating whether this message is a request message from the client to the server or a response message from the server to the client is set, for example.

An argument of a service request included in the “SOME/IP payload” is information included in a request message from a client to a server. An argument of a service request is information such as a numerical value that is used for processing related to a service that is carried out by the client, and is used when the client sets a condition and the like for processing a service. In the case of a service that does not need an argument, a request message does not need to include information regarding an argument.

A return value of a service request is information included in a response message from a server to a client. When, for example, transmission of information regarding the vehicle speed is requested in a request message, information regarding the vehicle speed is set as a return value in the response message. In addition, for example, if a service such as control of an in-vehicle device, not information transmission, is requested in a request message, a value indicating whether or not a requested control or the like has been performed properly is set as a return value in the response message.

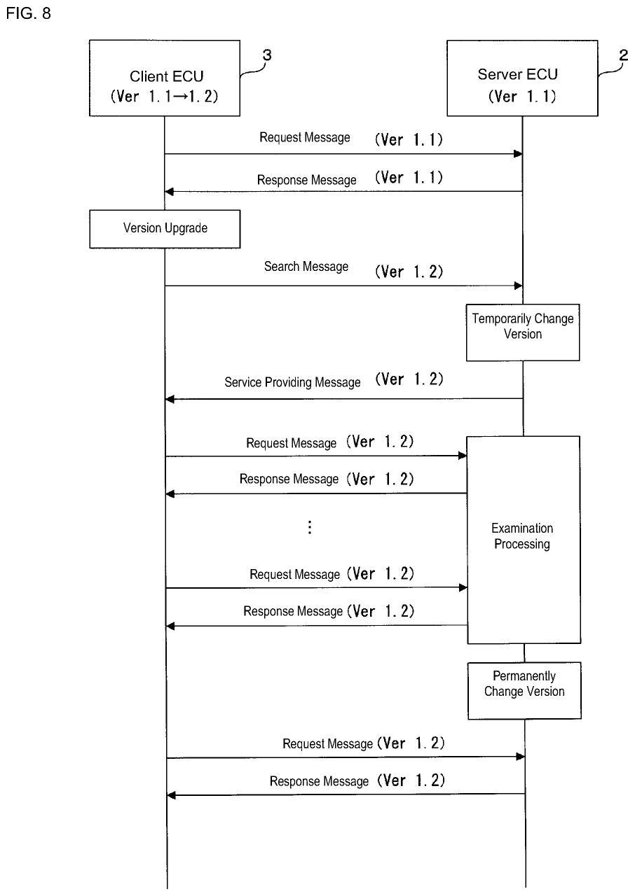

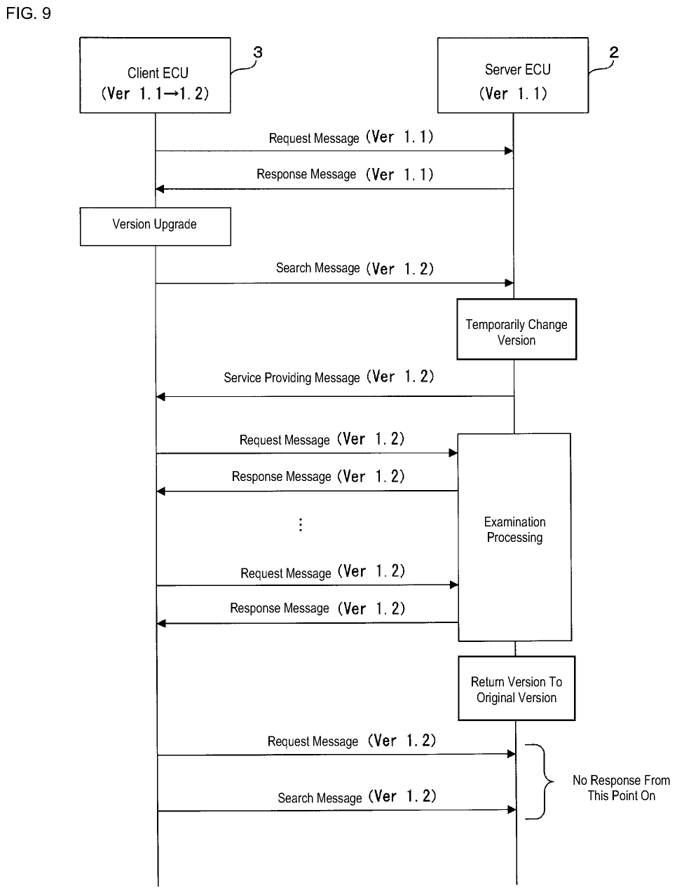

FIGS. 8 and 9 are schematic diagrams for illustrating an example of processing that is performed in the in-vehicle information processing system according to the present embodiment. FIGS. 8 and 9 show an example in which the service version of a service that the ECU 2 serving as a server provides is “1.1”, and the service version of a service requested by an ECU 3 serving as a client is upgraded from “1.1” to “1.2”. Before a version upgrade, the ECU 3 serving as a client transmits a request message in which the service version is set to “1.1”, to the ECU 2 serving as a server. Upon receiving this request message, the ECU 2 serving as a server carries out information processing for providing a service whose service version is “1.1”, and transmits a response message that includes a result of the information processing to the ECU 3 that made the request. The service version in the response message that is transmitted by the ECU 2 at this time is “1.1”.

Next, the ECU 3 serving as a client is subjected to a version upgrade of software (the client program 32a) for performing information processing using a service, and the service version is updated from “1.1” to “1.2”. In contrast, the software (the server program 22a) of the ECU 2 serving as a server that provides a service has not been subjected to a version upgrade, and the ECU 2 provides the service whose service version is “1.1”. In this situation, there is a risk that, even if the ECU 3 transmits, to the ECU 2, a search message and a request message in which the service version is set to “1.2”, the ECU 2 cannot transmit a service providing message and a response message to the ECU 3 since the service versions are different.

After the version upgrade is complete, the ECU 3 serving as a client transmits a search message in which the service version is set to “1.2”. The ECU 2 serving as a server according to the present embodiment receives this search message, and thereby can recognize that a service whose service ID matches the service ID of the service that the ECU 2 provides, and whose service version is different has been requested by the ECU 3.

In view of this, the ECU 2 temporarily changes the version of the service to be provided to the ECU 3 from “1.1” to “1.2”. The ECU 2 transmits a service providing message in which the service version is set to “1.2”, to the ECU 3 that transmitted the search message. The ECU 2 then starts examination processing for examining whether or not the service whose service version is “1.1” and that the ECU 2 provides can be used for information processing that is performed by the ECU 3 that has requested the service whose service version is “1.2”.

The ECU 2 then receives a request message in which the service version is “1.2”, and that has been transmitted from the ECU 3, determines whether or not the received request message is proper, and transmits a response message in response to the request message, to the ECU 3 that made the request. The service version in the response message that the ECU 2 transmits at this time is set to “1.2”. The ECU 2 determines whether or not the request message received from the ECU 3 is proper, based on, for example, whether or not various types of ID information and the like included in the request message have proper values, whether or not a change in the session ID in the request message is proper, and whether or not the value of the payload in the request message is within a proper range.

The ECU 2 continues to perform examination processing until a predetermined number of request messages are received from the ECU 3, and, when the predetermined number of request messages have been received, performs a final determination as to whether or not the ECU 3 can be provided with the service of the different service version, based on the result of determination as to whether or not each of the request messages is proper. If, for example, the number of messages determined as being proper, from among the predetermined number of received request messages, exceeds a threshold value, the ECU 2 determines that ECU 3 can be provided with the service of the different service version. If the number of messages determined as being proper does not exceed the threshold value, the ECU 2 determines that the ECU 3 cannot be provided with the service of the different service version.

If it is determined in the examination processing that the ECU 3 can use the service whose service version is “1.1” (see FIG. 8), the ECU 2 permanently changes the version of the service that is to be provided to the ECU 3, to “1.2”. The ECU 2 then receives a request message in which the service version is set to “1.2” and that has been transmitted from this ECU 3, performs information processing for providing the service whose service version is “1.1”, sets the service version in a response message that includes this processing result to “1.2”, and transmits the response message to the ECU 3.

In the examination processing, if it is determined that the ECU 3 cannot use the service whose service version is “1.1” (see FIG. 9), the ECU 2 returns the service version temporarily changed for examination processing from “1.2” to “1.1”. Next, if a request message and a search message in which the service version are set to “1.2” are received from the ECU 3, the ECU 2 does not transmit a response message and a service providing message in response to the search message. That is to say, the ECU 2 does not respond to a request message and a search message in which the service version is different and which are to be received from this point on from an ECU 3 to which the service cannot be provided as determined using examination processing, and will not repeatedly perform examination processing.

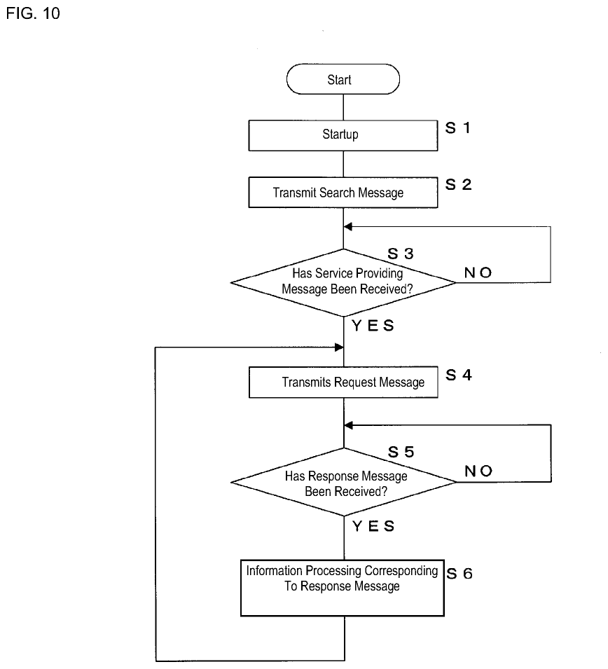

FIG. 10 is a flowchart showing the procedure of processing that is performed by an ECU 3 serving as a client according to the present embodiment. The ECU 3 according to the present embodiment is started, for example, at a timing when the ignition switch of the vehicle 1 is switched from an off-state to an on-state (step S1). After startup, the service searching unit 310a of the processing unit 31 of the ECU 3 transmits, through multicasting, a search message for searching for a server that can provide a service that the ECU 3 needs (step S2). Next, the service searching unit 310a determines whether or not a service providing message transmitted by the server as a response to the transmitted search message, or a service providing message that the server periodically transmits has been received (step S3). If a service providing message has not been received (step S3: NO), the service searching unit 310a stands by until a service providing message is received.

If a service providing message has been received (step S3: YES), the application processing unit 310b starts information processing that uses the service provided by the ECU 2 that has transmitted the service providing message, and transmits a request message to the ECU 2 serving as a server (step S4). The application processing unit 310b determines whether or not a response message from the ECU 2 serving as a server has been received in response to the request message transmitted in step S4 (step S5). If a response message has not been received (step S5: NO), the application processing unit 310b stands by until a response message is received. If a response message has been received (step S5: YES), the application processing unit 310b performs information processing corresponding to information included in the received response message (step S6), and returns the procedure to step S4.

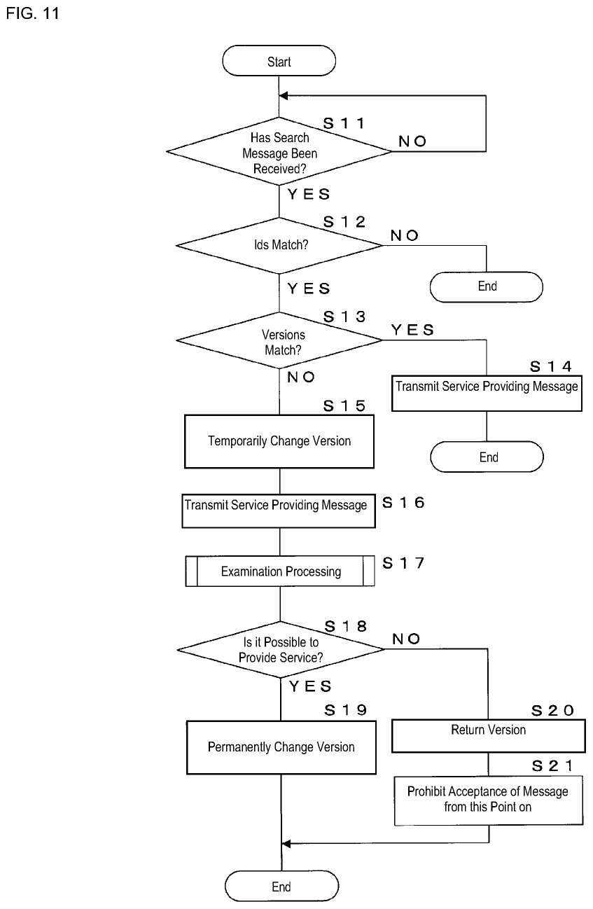

FIG. 11 is a flowchart showing the procedure of processing that is performed by the ECU 2 serving as a server according to the present embodiment. The service information providing unit 210a of the processing unit 21 of the ECU 2 serving as a server according to the present embodiment determines whether or not a search message transmitted by an ECU 3 serving as a client has been received (step S11). If a search message has been received (step S11: YES), the service information providing unit 210a determines whether or not the service ID included in the search message matches the service ID of the service that the ECU 2 provides (step S12). If the service IDs do not match (step S12: NO), the service information providing unit 210a ends the procedure without transmitting a service providing message.

If the service IDs match (step S12: YES), the service information providing unit 210a determines whether or not the service version included in the received search message matches the service version of the service that the ECU 2 provides (step S13). If the service versions match (step S13: YES), the service information providing unit 210a transmits a service providing message to the ECU 3 that transmitted the search message (step S14), and ends the procedure.

If the service versions do not match (step S13: NO), the service information providing unit 210a temporarily changes the service version of the service that the ECU 2 provides, to the service version included in the received search message (step S15). The service information providing unit 210a then transmits a service providing message in which the temporarily changed service version is set, to the ECU 3 that has transmitted the search message (step S16).

The service examination unit 210b of the processing unit 21 then performs examination processing that is based on the request message and the response message transmitted/received to/from the ECU 3 (step S17). The service examination unit 210b determines whether or not it is possible to provide, to the ECU 3, a service of a service version different from the service version included in the search message, in other words, the service of a service version that the ECU 2 can provide, based on the result of the examination processing performed in step S17 (step S18). If it is determined that the service can be provided (step S8: YES), the service examination unit 210b permanently changes the service version of the service that is provided to the ECU 3 serving as a client (step S19), and ends the procedure.

If it is determined that the service can be provided (step S18: NO), the service examination unit 210b returns the service version that has been temporarily changed in step S15, to the original service version (step S20). The service examination unit 210b prohibits acceptance of a search message and a request message with a different service version that are to be received from this point on from the client ECU 3 that is an examination processing target (step S21), and ends the procedure.

Note that a configuration may be adopted in which the ECU 2 stores, in the storage unit 22, a table or the like in which identification information of an ECU 3 serving as a client subjected to examination processing, information such as a service ID and a service version of a service requested by this ECU 3, and a result of examination processing are associated with each other, and when a similar search message or request message is received from the ECU 3 subjected to examination, the ECU 2 determines whether or not to respond to the received message by referring to this table. It is possible to perform processing for permanently changing the service version in step S19, processing for prohibiting acceptance of a message afterword in step S21, and the like in the above flowchart, as a result of the ECU 2 setting appropriate information in this table.

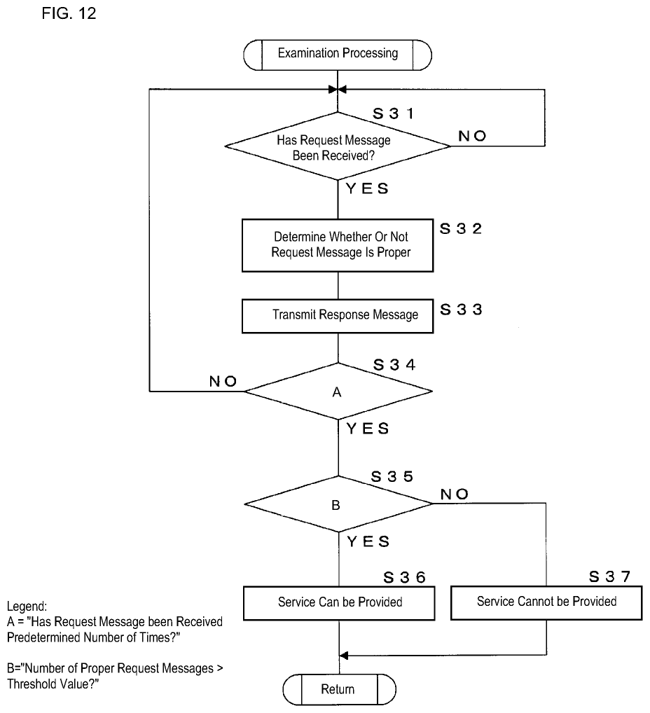

FIG. 12 is a flowchart showing the procedure of examination processing that is performed by the ECU 2 serving as a server according to the present embodiment, and shows detailed processing performed in step S17 in the flowchart shown in FIG. 11. The service examination unit 210b of the processing unit 21 of the ECU 2 according to the present embodiment determines whether or not a request message has been received from an ECU 3 that is an examination target (step S31). If a request message has not been received (step S31: NO), the service examination unit 210b stands by until a request message is received.

If a request message has been received (step S31: YES), the service examination unit 210b determines whether or not the received request message is proper (step S32). At this time, the service examination unit 210b can determine whether or not the received request message is proper based on, for example, whether or not various types of ID information and the like included in the request message have proper values, whether or not a change in the session ID in the request message is proper, and whether or not the value of a payload of the request message is within a proper range. The service examination unit 210b transmits a response message in response to the received request message, to the ECU 3 that transmitted the request message (step S33). The response message that the ECU 2 transmits at this time may be a response message in which proper information is stored, or a response message in which a predetermined value is stored for examination. The service examination unit 210b determines whether or not a request message has been received a predetermined number of times from the ECU 3 that is an examination target (step S34). If a request message has not been received a predetermined number of times (step S34: NO), the service examination unit 210b returns the procedure to step S31.

If a request message has been received the predetermined number of times (step S34: YES), the service examination unit 210b determines whether or not the number of request messages determined as being proper from among the predetermined number of received request messages exceeds a threshold value (step S35). If the number of proper request messages exceeds the threshold value (step S35: YES), the service examination unit 210b determines that this service can be provided to the ECU 3 that is an examination target (step S36), ends the examination processing, and returns the procedure to the flowchart in FIG. 11. If the number of proper request messages does not exceed the threshold value (step S35: NO), the service examination unit 210b determines that this service cannot be provided to the ECU 3 that is an examination target (step S37), ends the examination processing, and returns the procedure to the flowchart in FIG. 11.

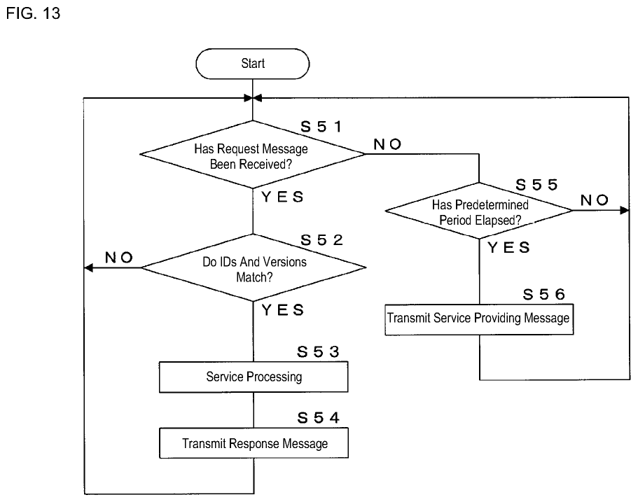

FIG. 13 is a flowchart showing the procedure of other processing that is performed by the ECU 2 serving as a server according to the present embodiment. The application processing unit 210c of the processing unit 21 of the ECU 2 serving as a server according to the present embodiment determines whether or not a request message transmitted by the ECU 3 serving as a client has been received (step S51). If a request message has been received (step S51: YES), the application processing unit 210c determines whether or not the service ID and the service version included in the received request message respectively match the service ID and the service version of the service that the ECU 2 provides (step S52). If the service IDs and service versions do not match (step S52: NO), the application processing unit 210c returns the procedure to step S51.

If the service IDs and service versions match (step S52: YES), the application processing unit 210c performs information processing for providing the requested service, based on the information included in the received request message (step S53). The application processing unit 210c transmits a response message that includes information obtained as a result of information processing, to the ECU 3 that transmitted the request message (step S54), and returns the procedure to step S51.

If a request message has not been received (step S51: NO), the service information providing unit 210a of the processing unit 21 determines whether or not a predetermined period has elapsed from the previous transmission in periodical transmission of a service providing message (step S55). If the predetermined period has elapsed (step S55: YES), the service information providing unit 210a periodically transmits a service providing message (step S56), and returns the procedure to step S51. If the predetermined period has not elapsed (step S55: NO), the service information providing unit 210a returns the procedure to step S51.

### Overview

The server processing unit 210 of the ECU 2 serving as a server according to the present embodiment has the above-described configuration, and receives a search message for searching for a service, from the client processing unit 310 of an ECU 3 serving as a client that requests that a service be provided. This search message includes the service ID and the service version of a service that the client processing unit 310 needs, and the server processing unit 210 determines whether or not the service version included in the received search message and the service version of the service that the server processing unit 210 provides match. If the two service versions match, the server processing unit 210 performs information processing for providing this service to the client processing unit 310. If the two service versions do not match, the server processing unit 210 performs examination processing on whether or not the client processing unit 310 can be provided with the service of a different service version. As a result of examination processing, if the client processing unit 310 can be provided with the service of a different service version, the server processing unit 210 performs information processing for providing the service requested by the client processing unit 310. Accordingly, the processing unit 210 of the ECU 2 serving as a server can avoid a situation where the client processing unit 310 cannot receive a service due to a mismatch between service versions of the service, whenever possible.

In addition, in the present embodiment, as a result of examination processing, if the client processing unit 310 can be provided with the service of a different service version, the server processing unit 210 first changes the service version of a service that the server processing unit 210 is to provide, to the service version in the search message received from the client processing unit 310. Accordingly, a mismatch between service versions will not occur from this point on, and the client processing unit 310 can smoothly perform processing.

In addition, in the present embodiment, when examining whether or not the client processing unit 310 can be provided with the service of a different service version, the server processing unit 210 first temporarily changes the service version of the service that the server processing unit 210 provides, to the service version included in the search message received from the client processing unit 310. Next, the server processing unit 210 transmits/receives a message related to the provision of the service to/from the client processing unit 310, based on the changed service version. The server processing unit 210 examines whether or not the client processing unit 310 can be provided with the service of a different service version, based on the result of transmitting/receiving this message. Accordingly, the ECU 2 can examine whether or not a failure will occur and the like when the service version of the service that the ECU 2 provides is changed to the service version of the service that the client processing unit 310 of the ECU 3 desires to be provided.

In addition, in the present embodiment, the server processing unit 210 of the ECU 2 receives, from the client processing unit 310 of the ECU 3, a search message for searching for a service desired to be provided, and transmits a service providing message that includes information such as the service ID and the service version of the service that the server processing unit 210 is to provide, as a response to this search message. Accordingly, when the client processing unit 310 needs a service providing message from the server processing unit 210, the client processing unit 310 can transmit a search message and receive a service providing message.

In addition, in the present embodiment, the server processing unit 210 of the ECU 2 repeatedly transmits, in a predetermined cycle, a service providing message that includes information such as the service ID and the service version of the service that the server processing unit 210 provides. Accordingly, the client processing unit 310 receives a periodically transmitted service providing message, and can determine whether or not the service that the ECU 3 needs is provided, and determine which server processing unit 210 provides the service.

Moreover, in the in-vehicle information processing system according to the present embodiment, the server processing unit 210 is included in the ECU 2, and the client processing unit 310 is included in an ECU 3. The server processing unit 210 of the ECU 2 transmits/receives messages to/from the ECU 3 that include the client processing unit 310. Accordingly, the ECU 2 can perform information processing for providing a service that another apparatus needs.

Note that, in the present embodiment, a configuration is adopted in which the ECUs 2 and 3 of the in-vehicle information processing system transmit/receive messages related to a service in accordance with the SOME/IP standard, but there is no limitation thereto, and a configuration may also be adopted in which messages are transmitted/received in accordance with a standard other than the SOME/IP standard. A technique described in the present embodiment can be used in any system in which a server and a client transmit/receive messages to/from each other.

### Modified Example 1

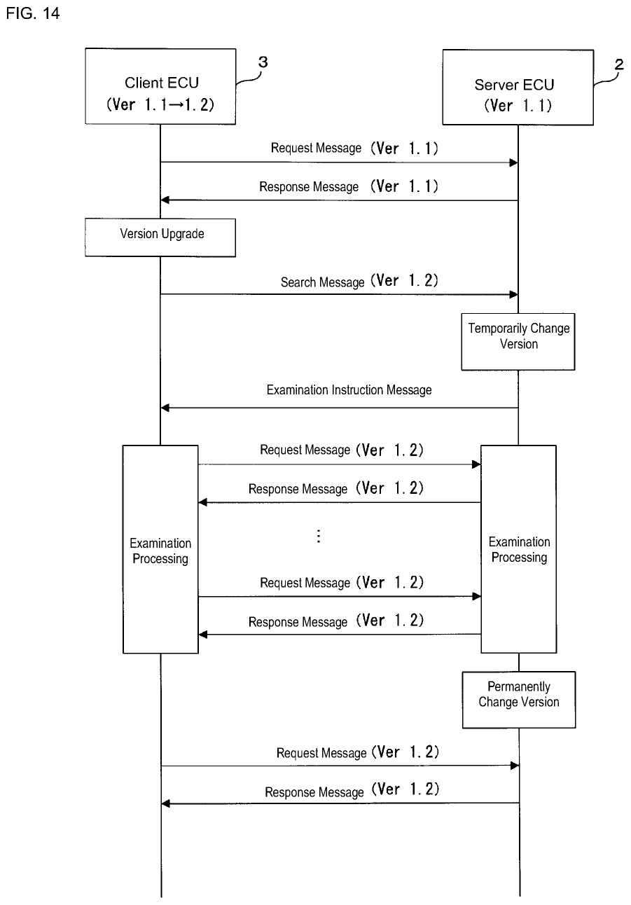

FIG. 14 is a schematic diagram for illustrating an example of processing that is performed by an in-vehicle information processing system according to Modified Example 1. In the in-vehicle information processing system according to Modified Example 1, when examining whether or not the service of a different service version can be provided to an ECU 3, the ECU 2 serving as a server first transmits an examination instruction message to the ECU 3 that is an examination target. The examination instruction message is a message for causing the ECU 3 to temporarily stop normal information processing, and transmit a request message required for the ECU 2 to perform examination processing. The examination instruction message can include information such as the type and the transmission order of a message that the ECU 3 is to transmit.

The ECU 3 serving as a client that has received the examination instruction message temporarily stops information processing that the ECU 3 itself is performing, and repeats transmission of a request message and receiving of a response message based on the information included in the examination instruction message. The ECU 2 serving as a server receives a request message transmitted by the ECU 3 and determines whether or not the request message is proper, and transmits a response message to the ECU 3 in response to the request message. The service version of the request message and the response message transmitted/received at this time is set to “1.2”.

The ECU 3 transmits a predetermined number of request messages in accordance with the examination instruction message. After transmitting a predetermined number of request messages, the ECU 3 may resume the temporarily stopped information processing that the ECU 3 was performing. The ECU 2 continues to perform examination processing until a predetermined number of request messages are received from the ECU 3, and when a predetermined number of request messages are received, performs final determination as to whether or not the ECU 3 can be provided with the service of a different service version, based on the determination result on whether or not each request message is proper. If it is determined in examination processing that the ECU 3 can use the service whose service version is “1.1”, the ECU 2 permanently changes the version of the service that is to be provided to the ECU 3, to “1.2”. The ECU 2 then receives a request message in which the service version is set to “1.2” and which is transmitted from this ECU 3, performs information processing for providing the service whose service version is “1.1”, sets the service version in a response message that includes this processing result to “1.2”, and transmits the response message to the ECU 3.

In the in-vehicle information processing system according to Modified Example 1 that has the above-described configuration, the server processing unit 210 of the ECU 2 serving as a server transmits, to the client processing unit 310 of the ECU 3 serving as a client, an examination instruction message for transmitting a predetermined request message. The client processing unit 310 transmits a request message in response to this examination instruction message. The server processing unit 210 performs examination based on a request message transmitted by the client processing unit 310 in response to the examination instruction message. Accordingly, the server processing unit 210 can more accurately examine whether or not the client processing unit 310 can be provided with the service of a different service version.

### Modified Example 2

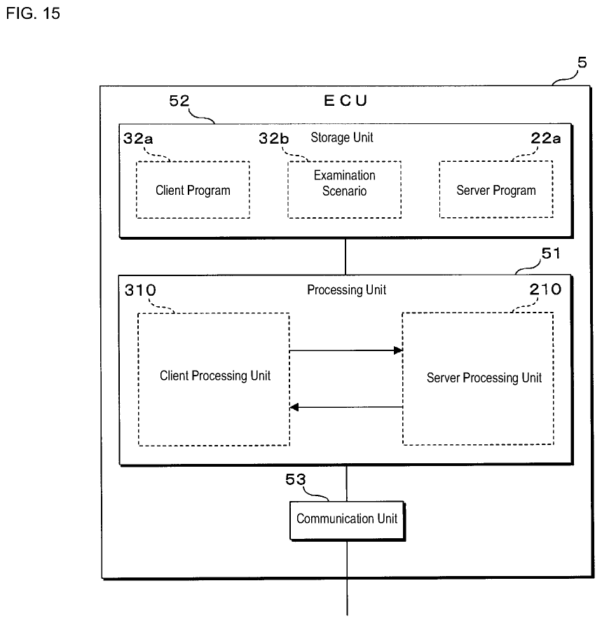

FIG. 15 is a schematic diagram for illustrating the configuration of an in-vehicle information processing system according to Modified Example 2. In the in-vehicle information processing system according to Modified Example 2, one ECU 5 includes both a client processing unit 310 and a server processing unit 210. The ECU 5 according to Modified Example 2 is constituted by a processing unit 51, a storage unit 52, a communication unit 53, and the like. The storage unit 52 includes the client program 32a and the server program 22a. In the ECU 5, the client processing unit 310 is realized as a software-like function unit by the processing unit 51 reading out and executing the client program 32a stored in the storage unit 52. Similarly, in the ECU 5, the server processing unit 210 is realized as a software-like function unit by the processing unit 51 reading out and executing the server program 22a. The processing unit 51 can, for example, operate a plurality of programs in parallel through time-sharing, and the client processing unit 310 and the server processing unit 210 operate in parallel.

In the ECU 5 according to Modified Example 2, the client processing unit 310 and the server processing unit 210 can transmit and receive a request message and a response message, and can transmit and receive a search message and a service providing message, without communicating with an external apparatus via the communication unit 53. Regardless of whether the server processing unit 210 is inside or outside the apparatus, the client processing unit 310 can perform processing for searching for a server processing unit 210 that provides a service required for processing that is performed by the client processing unit 310, processing for examining whether or not the service of a different service version can be received, processing for requesting the server processing unit 210 to provide a service, and the like.

In the in-vehicle information processing system according to Modified Example 2 that has the above-described configuration, the ECU 5 that includes the server processing unit 210 includes the client processing unit 310. Accordingly, the server processing unit 210 of the ECU 5 can provide a service to the client processing unit 310 in the apparatus, using a method similar to the method for providing a service to an external apparatus.

Each device in the in-vehicle information processing system is provided with a computer constituted by a microprocessor, a ROM, and a RAM. A computational processing unit such as a microprocessor may read out and execute a computer program including some or all of the steps of sequence diagrams or flowcharts, such as those shown in FIGS. 10 to 13, from a storage unit such as the ROM or RAM. The computer programs of these plurality of devices can each be installed from an external server device or the like. Also, the computer programs of these plural devices are each distributed in a state of being stored in a recording medium such as a CD-ROM, DVD-ROM or semiconductor memory.

The embodiment disclosed herein is to be considered as illustrative and non-limiting in all aspects. The scope of the present disclosure is indicated not by the above-stated meanings but by the scope of claims, and is intended to include all modifications that are within the meanings and the scope that are equivalent to those of the scope of claims.

1. An in-vehicle information processing apparatus comprising:
a server processing unit configured to perform processing for providing a service in response to a request,
wherein the server processing unit receives a search message for searching for a requested service, from a client processing unit configured to request that a service be provided,
the search message includes identification information and version information of the requested service,
the server processing unit determines whether or not the version information included in the received search message matches version information of a service that the server processing unit provides,
if it is determined that the two types of version information do not match, the server processing unit examines whether or not it is possible to provide the service with different version information to the client processing unit, and
if it is possible to provide the service with different version information, the server processing unit provides the service to the client processing unit.

2. The in-vehicle information processing apparatus according to claim 1, wherein, if it is possible to provide the service with different version information, the server processing unit changes version information of a service that is to be provided to the client processing unit from this point on, to the version information included in the search message.

3. The in-vehicle information processing apparatus according to claim 1, wherein the server processing unit temporarily changes the version information of the service that the server processing unit is to provide, to the version information included in the search message, transmits/receives a message to/from the client processing unit based on the temporarily changed version information, and performs examination as to whether or not it is possible to provide the service with different version information, based on a result of the transmitted/received messages.

4. The in-vehicle information processing apparatus according to claim 3, wherein the server processing unit gives the client processing unit an instruction to transmit a predetermined message, receives a message transmitted by the client processing unit in response to the instruction, and performs examination based on the received message.

5. The in-vehicle information processing apparatus according to claim 1, wherein the server processing unit receives a search message transmitted by the client processing unit in order to search for a service that the client processing unit desires to be provided, and
transmits, as a response to the search message, a service providing message that includes the identification information and the version information of the service that the server processing unit provides.

6. The in-vehicle information processing apparatus according to claim 1, wherein the server processing unit repeatedly transmits, in a predetermined cycle, a service providing message that includes the identification information and the version information of the service that the server processing unit provides.

7. The in-vehicle information processing apparatus according to claim 1, wherein the server processing unit transmits/receives a message to/from another apparatus that includes the client processing unit.

8. The in-vehicle information processing apparatus according to claim 1, further comprising:
the client processing unit.

9. An information processing method in which a server processing unit of an in-vehicle information processing apparatus performs processing for providing a service in response to a request from a client processing unit, the method comprising:
receiving a search message for searching for a requested service, from a client processing unit configured to request that a service be provided, the search message including identification information and version information of the requested service;
determining whether or not the version information included in the received search message matches version information of a service that the server processing unit is to provide;
if it is determined that the two types of version information do not match, examining whether or not it is possible to provide the service with different version information to the client processing unit; and
if it is possible to provide the service with different version information, providing the service to the client processing unit.

10. A server program for causing a computer mounted in a vehicle to execute processing for:
receiving a search message for searching for a requested service, from a client program for requesting that a service be provided, the search message including identification information and version information of the requested service;
determining whether or not the version information included in the received search message matches version information of a service that the server program provides;
if it is determined that the two types of version information do not match, examining whether or not it is possible to provide the service with different version information to the client program; and
if it is possible to provide the service with different version information, providing the service to the client program.
